(19) United States
(12) Patent Application Publication
(10) Pub. No.: US 2020/0356809 A1
(43) Pub. Date: Nov. 12, 2020

(54) FLEXIBLE PIPELINED BACKPROPAGATION

(71) Applicant: Vathys, Inc., Portland, OR (US)

(72) Inventor: Tapabrata Ghosh, Portland, OR (US)

(21) Appl. No.: 16/405,993

(22) Filed: May 7, 2019

(51) Int. Cl. G06K 9/62; G06K 9/66; G06N 3/08

(52) U.S. Cl. CPC G06K 9/6256; G06N 3/084; G06K 9/66

(57) ABSTRACT

Batch processing of artificial intelligence data can offer advantages, such as increased hardware utilization rates and parallelism for efficient parallel processing of data. However, batched processing in some cases can increase memory usage if batching is done without regards for its memory costs. For example, memory usage associate with batched-backpropagation can be substantial, thereby reducing desirable locality of processing data. System resources can be spent loading and traversing data inefficiently over the chip area. Disclosed are systems and methods for intelligent batching which utilizes a flexible pipelined forward and/or backward propagation to take advantage of parallelism in data, while maintaining desirable locality of data by reducing memory usage during forward and backward passes through a neural network or other AI processing tasks.

### BACKGROUND

### Field of the Invention

This invention relates generally to the field of artificial intelligence processors and more particularly to artificial intelligence accelerators.

### Description of the Related Art

Recent advancements in the field of artificial intelligence (AI) has created a demand for specialized hardware devices that can handle the computational tasks associated with AI processing. An example of a hardware device that can handle AI processing tasks more efficiently is an AI accelerator. The design and implementation of AI accelerators can present trade-offs between multiple desired characteristics of these devices. For example, in some accelerators, batching of data can be used to increase some desirable system characteristics, such as hardware utilization and increased efficiency due to task and/or data parallelism offered in batched data. Batching, however, can introduce costs, such as increased memory usage.

One type of AI processing performed by AI accelerators is forward propagation and backpropagation of data through layers of a neural network. Existing hardware accelerators use batching of data during propagation to increase hardware utilization rates and implement techniques that offer efficiencies by utilizing task and/or data parallelism inherent in AI data and/or batched data. For example, multiple processor cores can be employed to perform matrix operations on discrete portions of the data in parallel. However, batching can introduce high memory usage, which can in turn reduce locality of AI data. For example, various weights associated with a neural network layer, may need to be stored in memory, so they can be updated during backpropagation. Therefore, the memory required to process a neural network through the forward and backward passes can grow as the batch size is increased. Loss of locality can slow down an AI accelerator, as the system spends more time shuttling data to various areas of the chip implementing the AI accelerator. As a result, systems and methods are needed to maintain locality of data, while taking advantage of parallelism in AI data processing.

### SUMMARY

In one aspect of the invention, a method of processing of a neural network is disclosed. The method includes: receiving input images in an input layer of the neural network; processing the input images in one or more hidden layers of the neural network; generating one or more output images from an output layer of the neural network, wherein the output images comprise the processed input images; and backpropagating and processing the one or more output images through the neural network, wherein at each time interval equal to temporal spacing, a number of output images equal to data width is backpropagated and processed through the output layer, hidden layers and input layer.

In one embodiment, one or both of data width and temporal spacing are modulated to decrease backpropagation memory usage and increase locality of activation map data.

In another embodiment, temporal spacing comprises one or more time-steps, at least partly based on a clock signal.

In one embodiment, the data width starts from an initially high value and gradually ramps down at each time interval equal to the temporal spacing and data width resets to the initially high value in time interval subsequent to time interval in which data width reached one.

In some embodiments, the data width starts a from an initially low value and gradually ramps up at each time interval equal to the temporal spacing until the data width reaches an upper threshold and wherein the data width resets to the initially low value in the next time interval relative to the time interval in which the data width reached the upper threshold.

In one embodiment, the processing of the input images and/or the backpropagation processing comprise one or more of re-computation and gradient checkpointing.

In another embodiment, the backpropagation processing comprises stochastic gradient descent (SGD).

In one embodiment, the method further includes training of the neural network, wherein the training includes: forward propagating the backpropagated output images through the neural network; and repeating the forward propagating and backpropagating and updating parameters of the neural network during the backpropagation until a minimum of an error function corresponding to trained parameters of the neural network are determined.

In one embodiment, data width and/or temporal spacing are fixed from beginning to end of the training, or dynamically changed during the training, or are determined by a combination of fixing and dynamically changing during the training.

In one embodiment, an neural network accelerator implements the method and the accelerator is configured to store forward propagation data and/or backpropagation data such that output of a layer of the neural network, during forward propagation or backpropagation, is stored physically adjacent or close to a memory location where a next or adjacent layer of the neural network loads its input data.

In another aspect of the invention, a neural network accelerator is disclosed. The accelerator is configured to implement the processing of a neural network and the accelerator includes: one or more processor cores each having a memory module, wherein the one or more processor cores are configured to: receive input images in an input layer of the neural network; process the input images in one or more hidden layers of the neural network; generate one or more output images from an output layer of the neural network, wherein the output images comprise the processed input images; and backpropagate and process the one or more output images through the neural network, wherein at each time interval equal to temporal spacing, a number of output images equal to data width is backpropagated and processed through the output layer, hidden layers and input layer.

In one embodiment, one or both of data width and temporal spacing are modulated to decrease backpropagation memory usage and increase locality of activation map data.

In another embodiment, temporal spacing includes one or more time-steps, at least partly based on a clock signal.

In some embodiments, the data width starts from an initially high value and gradually ramps down at each time interval equal to the temporal spacing and data width resets to the initially high value in time interval subsequent to time interval in which data width reached one.

In one embodiment, the data width starts a from an initially low value and gradually ramps up at each time interval equal to the temporal spacing until the data width reaches an upper threshold and wherein the data width resets to the initially low value in the next time interval relative to the time interval in which the data width reached the upper threshold.

In some embodiments, the processing of the input images and/or the backpropagation processing comprise one or more of re-computation and gradient checkpointing.

In another embodiment, the backpropagation processing comprises stochastic gradient descent (SGD).

In some embodiments, the one or more processor cores are further configured to train the neural network, wherein the training includes: forward propagating the backpropagated output images through the neural network; and repeating the forward propagating and backpropagating and updating parameters of the neural network during the backpropagation until a minimum of an error function corresponding to trained parameters of the neural network are determined.

In one embodiment, data width and/or temporal spacing are fixed from beginning to end of the training, or dynamically changed during the training, or are determined by a combination of fixing and dynamically changing during the training.

In another embodiment, the accelerator is further configured to store forward propagation data and/or backpropagation data such that output of a layer of the neural network, during forward propagation or backpropagation, is stored physically adjacent or close to a memory location where a next or adjacent layer of the neural network loads its input data.

### BRIEF DESCRIPTION OF THE DRAWINGS

These drawings and the associated description herein are provided to illustrate specific embodiments of the invention and are not intended to be limiting.

FIG. 1 illustrates a diagram of a multilayered neural network where batching is used.

FIG. 2 illustrates a diagram of an example of a flexible pipelined backpropagation through a neural network.

FIG. 3 illustrates an example three-layered network where principles of flexible pipelined propagation is applied.

FIG. 4 illustrates the neural network of the embodiment of FIG. 3 in steady state.

FIG. 5 illustrates the neural network of the embodiment of FIG. 3, where data width N is used both in forward and backpropagation.

FIG. 6 illustrates a spatially-arranged accelerator, which can be configured to implement the neural network of the embodiment of FIG. 3.

FIG. 7 illustrates a flow chart of a method of processing in a neural network according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Definitions

“image,” for example as used in “input image” can refer to any discrete data or dataset representing a physical phenomenon, which can be input or processed through various stages and/or layers of an artificial intelligence (AI) model, such as a neural network. Example images can include binary representations of still photographs, video frames, an interval of speech, financial data, weather data, or any other data or data structure suitable for AI processing.

“Compute utilization,” “compute utilization rate,” “hardware utilization,” and “hardware utilization rate,” can refer to the utilization rate of hardware available for processing AI models such as neural networks, deep learning or other software processing.

Artificial intelligence (AI) techniques have recently been used to accomplish many tasks. Some AI algorithms work by initializing a model with random weights and variables and calculating an output. The model and its associated weights and variables are updated using a technique known as training. Known input/output sets are used to adjust the model variables and weights, so the model can be applied to inputs with unknown outputs. Training involves many computational techniques to minimize error and optimize variables. One example of a model commonly used is neural networks. An example of a training method used to train neural network models is backpropagation, which is often used in training deep neural networks. Backpropagation works by calculating an error at the output and iteratively computing gradients for layers of the network backwards throughout the layers of the network. An example of a backpropagation technique used is stochastic gradient descent (SGD).

Additionally, hardware can be optimized to perform AI operations more efficiently. Hardware designed with the nature of AI processing tasks in mind can achieve efficiencies that may not be available when general purpose hardware is used to perform AI processing tasks. Hardware assigned to perform AI processing tasks can also or additionally be optimized using software. An AI accelerator implemented in hardware, software or both is an example of an AI processing system which can handle AI processing tasks more efficiently.

One way in which AI processors can accelerate AI processing tasks is to take advantage of parallelism inherent in these tasks. For example, many AI computation workloads include matrix operations, which can in turn involve performing arithmetic on rows or columns of numbers in parallel. Some AI processors use multiple processor cores to perform the computation in parallel. Multicore processors can use a distributed memory system, where each processor core can have its dedicated associated memory, buffer and storage to assist it in carrying out processing. Yet another technique to improve the efficiency of AI processing tasks is to use spatially-arranged processors with distributed memories. Spatially-arranged processors can be configured to maintain desirable spatial locality in storing their processing output, relative to the subsequent processing steps. For example, operations of a neural network can involve processing input data (e.g., input images) through multiple neural network layers, where the output of each layer is the input of the next layer. Spatially-arranged processors can keep the data needed to process that layer close to the data associated with that layer by storing them in physically-close memory locations. The subsequent and associated data are stored physically nearby and so forth for each layer of the neural network.

When performing AI processing tasks, some AI processors use or are configured to use batching both to increase hardware utilization rates and to take advantage of parallelism across multiple data inputs. Batching can refer to inputting and processing multiple data inputs through the AI network.

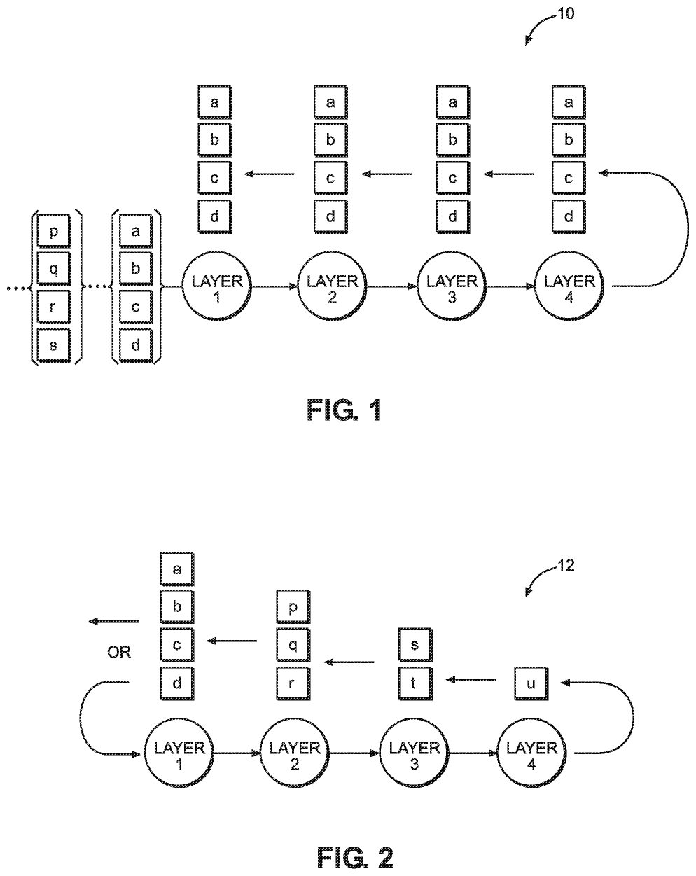

FIG. 1 illustrates a diagram of a multilayered neural network 10 where batching is used. For illustration purposes, the neural network 10 includes four layers, but fewer or more layers are possible. Input data is batched and propagated forward through the neural network 10. For illustration purposes, each batch includes 4 input images, but fewer or more input images in each batch is possible. Two batches are illustrated, a first batch includes input images, a, b, c and d and a second batch includes input images p, q, r and s. Batched-backpropagation is used to backpropagate the output of the processing of input images backward through the layers of the neural network 10 to calculate, recalculate, minimize one or more error functions and/or to optimize the weights and variables of the neural network 10.

Batched-backpropagation, similar to batching at input during forward propagation, can increase hardware utilization, for example when processing is performed on graphics processing units (GPUs). However, batched-backpropagation can greatly increase memory usage and, in some cases, decrease desired spatial locality in the stored data. When performing backpropagation, the processor implementing the neural network 10, in some cases, stores data associated with input images as they traverse through the network back and forth. Previous values of weights and variables are stored, recalled and used to perform backpropagation and minimize output error. As a result, some data is kept in memory until their subsequent computations no longer require them. Batching can increase memory reserved for such storage. Thus, in some cases, when batching is used, the memory consumption can be substantial, thereby negatively impacting other desirable network characteristics, such as processing times and/or spatial locality.

Some terminology will herein be defined utilizing the illustration of the neural network 10. The terminology is nonetheless applicable to other cases. “Data width” (denoted herein by “N”) can refer to the number of discrete inputs that are propagated and processed forward or backward through the neural network 10 in parallel at each time-step. Data width during backpropagation can refer to the number of discrete inputs fed backward and in parallel through the layers of the neural network 10 at each time-step. In batched-backpropagation illustrated in FIG. 1 data width N is four as four input images are fed in parallel, backward through the neural network 10. The term “temporal spacing” (denoted herein by “M”) can refer to how many time-steps apart, batched of input images are forward propagated or backpropagated through the neural network 10. Time-steps can refer to any discrete timing where the neural network 10 is updated, where updating can include a layer processing its input and outputting the result to the next layer, during forward or backward propagation. In some cases, time-steps are at least partially based on a clock signal of a central processing unit (CPU). For example, a time-step can be defined as the duration between the rising edges of a CPU clock signal. Examples of temporal spacing in relation to FIG. 1 can be four inputs arriving or backpropagated each time-step, where N=4 and M=1, or four input images arriving or backpropagated every other time-step, where N=4 and M=2. Data width and temporal spacing can be different for forward propagation of data in the neural network 10 compared to the backpropagation of data in neural network 10.

Data width N and temporal spacing M can be varied to allow the network 10 a chance to process a layer and its input data while reducing memory consumption and processing times compared to the case where a fixed data width is processed every time-step. In other cases, values of N and M can be chosen such that their associated memory cost would not detrimentally impact locality of AI processing data. For example, in one embodiment, during backpropagation, the data width can ramp up gradually (e.g., increase by one input image at each time-step), or data width can start large and ramp down gradually to a smaller data width (e.g., ramp down by one input image at each time-step). In other embodiments, the temporal spacing M can be increased such that the network 10 has a chance to process and clear some values from memory before the next batch arrives. In other embodiments, both data width N and temporal spacing M can be varied to allow the neural network 10 to reduce memory consumption.

The ability to vary data width and/or temporal spacing can enable flexible pipelining instead of or in addition to batching in backpropagation. The disclosed flexible pipelined backpropagation can trade off gained-efficiency in parallelism (achieved from batching) for reduced memory consumption.

FIG. 2 illustrates a diagram of an example of a flexible pipelined backpropagation through a neural network 12. Here to conserve memory, while still taking advantage of batching parallelism, N is reduced by one input image in each time-step (N=N−1). At each time-step, one less input image is backpropagated through the neural network 12. N can start from four and once reached one, N can reset to four and backpropagation feed can continue in this manner. The network 12 is shown in steady state, where all pipeline stages (the layers) are full (e.g., have inputs to process). The initial and terminal values of N can be determined based on a variety of factors, such as the nature, number and characteristics of input images, number of layers in the network 12, the memory usage associated with increase in data width, availability of hardware and/or memory resources and other characteristics of hardware implementing the network 12, input data and the workload processed in the network 12. In other embodiments, optimum values of data width and temporal spacing can be determined empirically.

Additionally, temporal spacing of the backpropagation feed can be variable. For example, in the diagram of FIG. 2, N=N−1 for each time-step if M=1. Alternatively, N can be reduced by one for every other time-step if M=2. In another embodiment, N can be fixed from start to end of training of neural network 12, while M is a value greater than one to allow the neural network 12 to process a fixed number of N inputs and free up associated memory before new batches of N inputs are backpropagated through the neural network 12.

When data width larger than one is used (N>1), the size of an activation map in a layer can become larger by a factor of N. When a temporal spacing larger than one (M>1) is used, the size of an activation map in a layer can be smaller by a factor of floor (1/M). The floor function is used to account for cases where the size of the activation map is not evenly divisible by M. In some embodiments, a continuous time relaxation of an SGD and/or backpropagation process can be used to allow M to be a non-integer number. If backpropagation and/or SGD can be modeled as a process acting upon an entity, they can be modeled with differential equations and thus, there can be fractional/non-integer timesteps (similar to fractional derivatives and integrals).

Using batched-backpropagation can increase hardware utilization rate, but it can also increase memory consumption. For example, given a data width of N for backpropagation, the memory usage is increased by a factor of N. This can decrease the locality of activation map data, where activation map is defined as the output of a layer in a neural network. Locality in this context can refer to how close the activation map is to where data processing will be performed upon it. The closer an activation map is to where data processing is performed upon it, the more efficient the processing and the neural network in general can be. For example, when locality of activation map data is increased, processor or processor cores implementing the neural network have to spend less time and energy moving data around and data movement can occur over shorter distances.

Some accelerators in the context of neural network, and other AI processing tasks, can be designed to create better locality of activation map data (or other AI processing data). One example of such processors can be referred to as spatially-arranged processors. Unlike processors having monolithic memory systems, spatially-arranged processors can have distributed memory systems, where for example, each processor core has a dedicated memory system. An example of a spatially-arranged processor is disclosed in U.S. patent application Ser. No. 16/365,475, entitled, “LOW LATENCY AND HIGH THROUGHPUT INFERENCE,” filed by Applicant on Mar. 26, 2019, the content of which is incorporated herein in its entirety. Other examples include Intelligent RAM (IRAM), described among other places in Patterson et al. (1997) “Intelligent RAM (IRAM): the industrial setting, applications, and architectures” Proceedings 1997 IEEE International Conference on Computer Design: VLSI in Computers and Processors (ICCD '97), pp 2-7; the REX NEO architecture; the Adapteva® Epiphany; Graphcore® intelligence processing unit (IPU) and others.

When large and/or inflexible batching is used, some processors, for example spatially-arranged processors may need to store larger amounts of activation map data associated with each layer, resulting in less locality of activation map data on the hardware. Larger memory storage demands due to batching can force some processors to store input data for a layer (output of a previous layer) further away from that layer. By contrast, the flexible pipelined backpropagation embodiments described herein can maintain locality of the activation map data.

Additionally, the described embodiments are also applicable to neural network architectures that utilize skip connections in backpropagation. Examples of such networks include residual networks, highway networks, DenseNets and others.

The described flexible pipelined backpropagation can enable an accelerator to choose values of backpropagation data width (N) and temporal spacing (M) in a manner to both take advantage of batching, while maintaining locality of activation map data. By contrast, when very shallow or very deep neural networks are used in systems with fixed data width and temporal spacing values (e.g., N=1 and M=1), disadvantages can be observed. For example, a neural network VGG-16 has sixteen layers. The achievable degree of parallelism from pipelining using these layers is approximately sixteen (the number of layers in the network), while batching in this network can offer 128 or more degrees of parallelism. So, batching (or increasing N) in this network (as opposed to maintaining N=1) can offer advantages in the form of increased parallelism, while the increase in memory usage and loss of locality can be acceptable.

Another neural network ResNet-1024 has 1024 layers. Although the total achieved parallelism can be quite high (˜1024), the extremely high memory usage may cause difficulty, especially for spatially-arranged accelerators with distributed memories. Memory usage in this context scales quadratically in relation to the number of layers used (e.g., for ResNet-1024 with N=1 and M=1, memory usage is approximately 1024\hat{ }2). Thus, the systems utilizing N=1 and M=1 can be highly inflexible and not of much practical use. By contrast, the flexible pipelined backpropagation embodiments described herein can vary data width and temporal spacing of backpropagation to take advantage of pipelining parallelism while maintaining locality of activation map data. Data width and temporal spacing of backpropagation can be varied statically (e.g., fixed from start to end of training of a network), dynamically (e.g., changed during and/or in between the training of a network) or by some combination of the two.

Additionally, the described flexible pipelined propagation can be effectively used in combination with techniques such as activation map re-computation and gradient checkpointing to alleviate some of the re-computation needs. Without re-computation, activation maps are removed from the memory when they have finished their forward pass through the last layer of a neural network. Consequently, more activation maps accumulate at earlier layers of a neural network. Re-computation of some activation maps, however, can allow removal of those activation maps from memory sooner, but the cost associated with re-computation can be significant. Re-computation can cost quadratically in resources needed as a function of layer depth. Flexible pipelined propagation can free up more memory and alleviate some of the quadratically-costly re-computation needs in shallowest layers of a neural network.

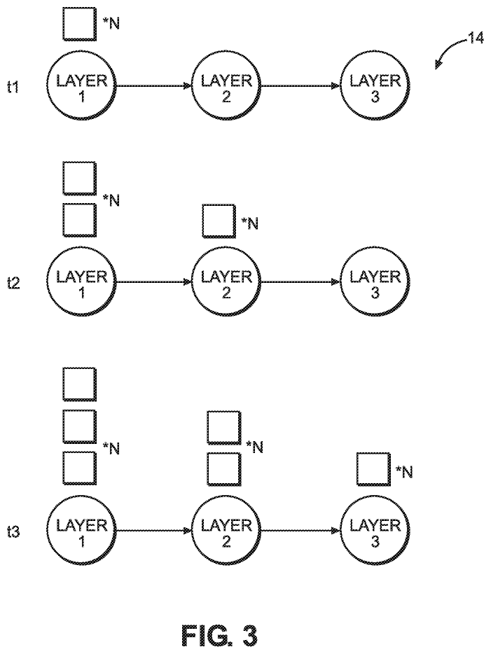

The principles of flexible pipelined backpropagation can also be applied during a forward propagation. FIG. 3 illustrates an example three-layered network 14 where the principles of flexible pipelined propagation is applied. At each time-step, data width N is increased by N image. Temporal spacing M can be fixed at one or increased to another number. If M=1, at time-step t1, N images are input in layer one, processed and outputted to layer two. At time-step t2, layer one receives 2N input images and layer two receives the N input images that were previously processed in layer one. At time-step t3, layer one receives 3N input images, layer two receives 2N input images and layer three receives N input images. At time-step t3, the pipeline formed by layers one, two and three reach steady state where every stage has inputs to process (or the pipeline formed by layers one, two and three is full).

Layer one can be an input layer, layer two can be one or more hidden layers of the neural network 14 and layer three can be an output layer. After time-step t3, the first N images that were processed are ready for backpropagation through layers three, two and one. Consequently, the time-steps t1, t2 and t3 can be considered as the prelude steps of a pipelined backpropagation. Since the forward feeding starts with fewer images (N) and gradually ramps up (from N, to 2N and 3N), the memory associated with layers of network 14 has a chance to process data and desirable locality of activation maps are preserved.

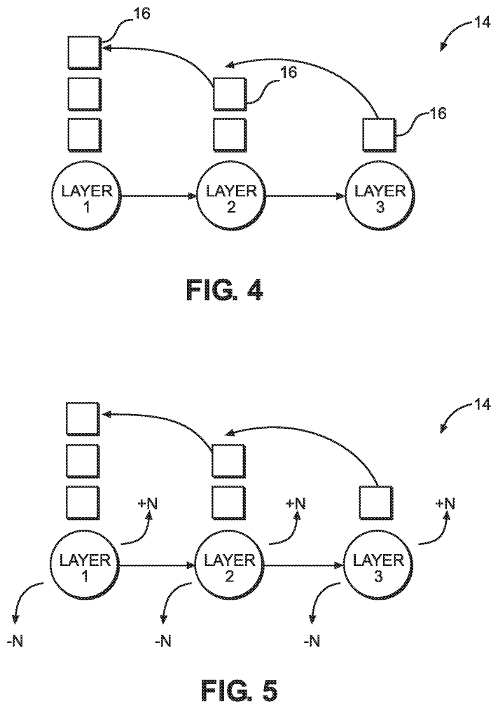

In some embodiments, backpropagation can start simultaneously while the forward propagation is in progress. FIG. 4 illustrates the neural network 14 in steady state or warm state. Input image 16 has finished processing through layers one, two and three. When the processing of input image 16 is concluded in final layer (layer three), the input image 16 is backpropagated through layers three, two and one.

FIG. 5 illustrates the neural network 14, where data width N is used both in forward and backpropagation. If temporal spacing of propagation is one (M=1), at each time-step, activation maps in each layer are increased by N new input images and decreased by N already-processed input images. For example, each time-step, layer three receives N new input images and propagates back N already-processed images to layer two. N can be chosen to maintain locality of activation map data within a desired limit. In some embodiments, the optimum values of N and/or M can be determined empirically for a chosen hardware.

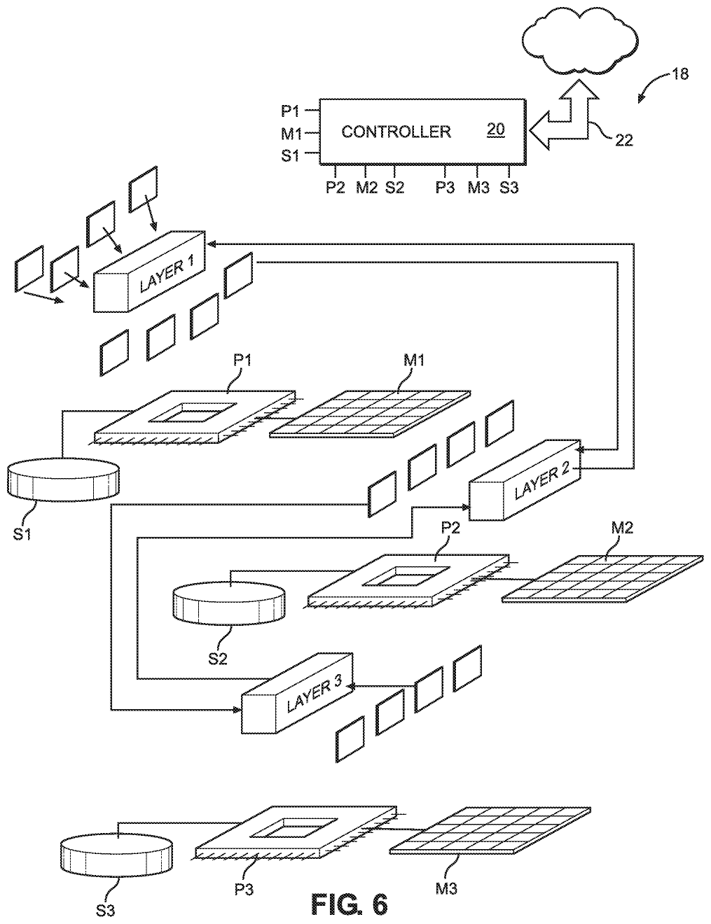

FIG. 6 illustrates a spatially-arranged accelerator 18, which can be configured to implement the neural network 14. The accelerator 18 can include multiple processor cores, for example P1, P2 and P3. Each processor core can be assigned to processing a layer in neural network 14. For example, P1 can be assigned to layer one, P2 can be assigned to layer two and P3 can be assigned to layer three. Processor cores P1, P2 and P3 can have dedicated memories or memory modules M1, M2 and M3, respectively. The memory modules in one embodiment can include static random-access-memory (SRAM) arrays. Processor cores can include processing hardware elements such as central processing units (CPUs), arithmetic logic units (ALUs), buses, interconnects, input/output (I/O) interfaces, wireless and/or wired communication interfaces, buffers, registers and/or other components. The processor cores P1, P2 and P3 can have access to one or more external storage, such as S1, S2 and S3, respectively. The external storage elements S1, S2 and S3 can include hard disk drive (HDD) devices, flash memory hard drive devices or other long-term memory devices.

The spatially-arranged accelerator 18 can include a controller 20, which can coordinate the operations of processor cores P1, P2, P3, memories M1, M2, M3 and external storage elements S1, S2 and S3. The controller 20 can be in communication with circuits, sensors or other input/output devices outside the accelerator 18 via communication interface 22. Controller 20 can include microprocessors, memory, wireless or wired I/O devices, buses, interconnects and other components.

In one embodiment, the spatially-arranged accelerator 18 can be a part of a larger spatially-arranged accelerator, having multiple processors and memory devices, where the processor cores P1, P2, P3 and their associated components are used to implement the neural network 14. The spatially-arranged accelerator 18 can be configured to store activation map data in a manner to take advantage of efficiencies offered by locality of data. As shown, the pipelined formed by layers one, two and three during forward or backpropagation can be configured on processor cores P1, P2 and P3, respectively, to increase or maximize locality of activation map data. In this configuration, the output of layer one is propagated to the adjacent processor and memory next to it, the processor core P2. Likewise, during backpropagation, the output of layer two is backpropagated to the processor core adjacent to it, the processor core P1. As can be seen, and as the number of processor cores increase, assigning hardware in a manner that follows the forward or backward propagation path of a neural network offers efficiencies of locality. Combined with flexible pipelined forward or backward propagation as described above, the accelerator 18 can offer an efficient hardware for processing neural networks.

Fewer or more processor cores are possible and the number of processor cores shown are for illustration purposes only. In one embodiment, a single processor/memory combination can be used while the controller 20 can manage the loading and storing of activation map data in order to maintain locality of activation map data. In one embodiment, the controller 20 and its functionality can be implemented in software, as opposed to hardware components to save on-chip area needed for accelerator 18. In other embodiments, the controller 20 and its functionality can be implemented in one or more of processors P1, P2 and P3.

In one embodiment, the accelerator 18 can be part of an integrated system, where accelerator 18 can be manufactured as a substrate/die, a wafer-scale integrated (WSI) device, a three-dimensional (3D) integrated chip, a 3D stack of two-dimensional (2D) chips, an assembled chip which can include two or more chips electrically in communication with one another via wires, interconnects, wired and/or wireless communication links (e.g., vias, inductive links, capacitive links, etc.). Some communication links can include dimensions less than or equal to 100 micrometers (um) in at least one dimension (e.g., Embedded Multi-Die Interconnect Bridge (EMIB) of Intel® Corporation., or silicon interconnect fabric).

In one embodiment, the multiple processor cores can utilize a single or distributed external storage. For example, processor cores P1, P2 and P3 can each use external storage S1.

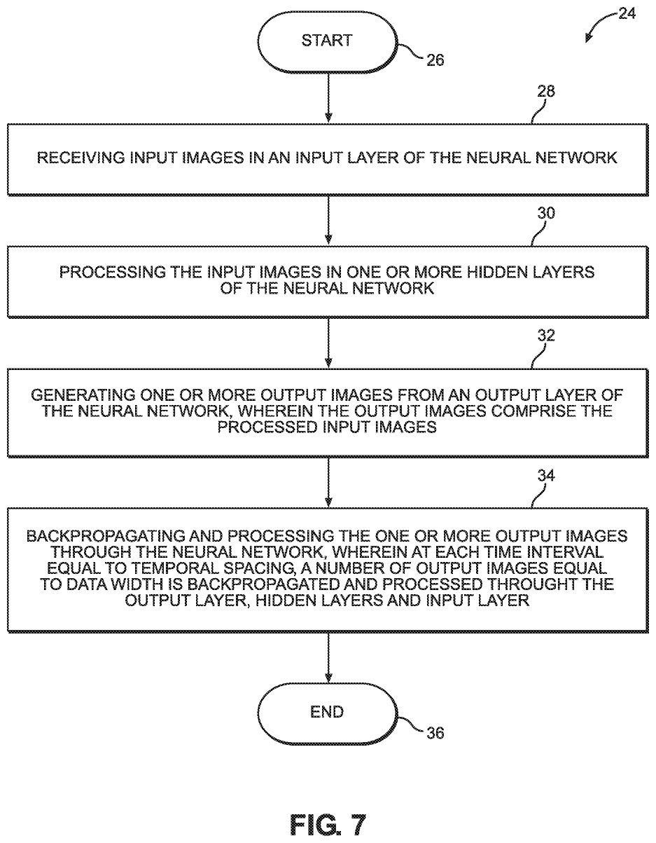

FIG. 7 illustrates a flow chart of a method 24 of processing of a neural network. The method starts at the step 26. The method continues to the step 28 by receiving input images in an input layer of the neural network. The method then moves to the step 30 by processing the input images in one or more hidden layers of the neural network. The method then moves to the step 32 by generating one or more output images from an output layer of the neural network, wherein the output images comprise the processed input images. The method then moves to the step 34 by backpropagating and processing the one or more output images through the neural network, wherein at each time interval equal to temporal spacing, a number of output images equal to data width is backpropagated and processed through the output layer, hidden layers and input layer. The method then ends at the step 36.

What is claimed is:

1. A method of processing of a neural network, comprising:
receiving input images in an input layer of the neural network;
processing the input images in one or more hidden layers of the neural network;
generating one or more output images from an output layer of the neural network, wherein the output images comprise the processed input images; and
backpropagating and processing the one or more output images through the neural network, wherein at each time interval equal to temporal spacing, a number of output images equal to data width is backpropagated and processed through the output layer, hidden layers and input layer.

2. The method of claim 1, wherein one or both of data width and temporal spacing are modulated to decrease backpropagation memory usage and increase locality of activation map data.

3. The method of claim 1, wherein temporal spacing comprises one or more time-steps, at least partly based on a clock signal.

4. The method of claim 1, wherein the data width starts from an initially high value and gradually ramps down at each time interval equal to the temporal spacing and data width resets to the initially high value in time interval subsequent to time interval in which data width reached one.

5. The method of claim 1, wherein the data width starts a from an initially low value and gradually ramps up at each time interval equal to the temporal spacing until the data width reaches an upper threshold and wherein the data width resets to the initially low value in the next time interval relative to the time interval in which the data width reached the upper threshold.

6. The method of claim 1, wherein the processing of the input images and/or the backpropagation processing comprise one or more of re-computation and gradient checkpointing.

7. The method of claim 1, wherein the backpropagation processing comprises stochastic gradient descent (SGD).

8. The method of claim 1 further comprising training of the neural network, wherein the training comprises:
forward propagating the backpropagated output images through the neural network; and
repeating the forward propagating and backpropagating and updating parameters of the neural network during the backpropagation until a minimum of an error function corresponding to trained parameters of the neural network are determined.

9. The method of claim 8 wherein data width and/or temporal spacing are fixed from beginning to end of the training, or dynamically changed during the training, or are determined by a combination of fixing and dynamically changing during the training.

10. An accelerator implementing the method of claim 1, wherein the accelerator is configured to store forward propagation data and/or backpropagation data such that output of a layer of the neural network, during forward propagation or backpropagation, is stored physically adjacent or close to a memory location where a next or adjacent layer of the neural network loads its input data.

11. An accelerator configured to implement the processing of a neural network, the accelerator comprising:
one or more processor cores each having a memory module, wherein the one or more processor cores are configured to:
receive input images in an input layer of the neural network;
process the input images in one or more hidden layers of the neural network;
generate one or more output images from an output layer of the neural network, wherein the output images comprise the processed input images; and
backpropagate and process the one or more output images through the neural network, wherein at each time interval equal to temporal spacing, a number of output images equal to data width is backpropagated and processed through the output layer, hidden layers and input layer.

12. The accelerator of claim 11, wherein one or both of data width and temporal spacing are modulated to decrease backpropagation memory usage and increase locality of activation map data.

13. The accelerator of claim 11, wherein temporal spacing comprises one or more time-steps, at least partly based on a clock signal.

14. The accelerator of claim 11, wherein the data width starts from an initially high value and gradually ramps down at each time interval equal to the temporal spacing and data width resets to the initially high value in time interval subsequent to time interval in which data width reached one.

15. The accelerator of claim 11, wherein the data width starts a from an initially low value and gradually ramps up at each time interval equal to the temporal spacing until the data width reaches an upper threshold and wherein the data width resets to the initially low value in the next time interval relative to the time interval in which the data width reached the upper threshold.

16. The accelerator of claim 11, wherein the processing of the input images and/or the backpropagation processing comprise one or more of re-computation and gradient checkpointing.

17. The accelerator of claim 11, wherein the backpropagation processing comprises stochastic gradient descent (SGD).

18. The accelerator of claim 11, wherein the one or more processor cores are further configured to train the neural network, wherein the training comprises:
forward propagating the backpropagated output images through the neural network; and
repeating the forward propagating and backpropagating and updating parameters of the neural network during the backpropagation until a minimum of an error function corresponding to trained parameters of the neural network are determined.

19. The accelerator of claim 18, wherein data width and/or temporal spacing are fixed from beginning to end of the training, or dynamically changed during the training, or are determined by a combination of fixing and dynamically changing during the training.

20. The accelerator of claim 11, wherein the accelerator is further configured to store forward propagation data and/or backpropagation data such that output of a layer of the neural network, during forward propagation or backpropagation, is stored physically adjacent or close to a memory location where a next or adjacent layer of the neural network loads its input data.
